(19) United States
(12) Patent Application Publication
(10) Pub. No.: US 2025/0381816 A1
(43) Pub. Date: Dec. 18, 2025

(54) Wheel Link Device for a Motor Vehicle, in Particular for a Passenger Car, and Motor Vehicle

(71) Applicant: Bayerische Motoren Werke Aktiengesellschaft, Muenchen (DE)

(72) Inventor: Mathias SCHMIDT, Muenchen (DE)

(21) Appl. No.: 18/878,309

(22) PCT Filed: Jul. 7, 2023
(86) PCT No.: PCT/EP2023/068816

§ 371 Date: Dec. 23, 2024

(30) Foreign Application Priority Data
Aug. 8, 2022 (DE) 10 2022 119 841.3

(51) Int. Cl. B60G 13/16; B60G 7/00

(52) U.S. Cl. CPC B60G 13/16; B60G 7/001; B60G 2202/22; B60G 2202/25

(57) ABSTRACT

A wheel link device for a motor vehicle has a wheel link as a first component, and a vibration absorber designed as a rotational absorber, wherein the vibration absorber has an absorber mass as a second component, which can be pivoted relative to the wheel link about a pivot axis, and has at least one coupling element, which is elastically deformable to damp the vibrations in the event of a respective relative rotation between the components about the pivot axis. At least one elastically deformable first buffer is provided, which in an idle position of the wheel link device is spaced apart from at least one of the components and therefore the first buffer prevents the wheel link from directly hitting the absorber mass. An elastically deformable second buffer is provided, which in the idle position is supported on both components.

### BACKGROUND AND SUMMARY

The invention relates to a wheel link device for a motor vehicle, in particular for a passenger car. The invention also relates to a motor vehicle, in particular a passenger car, comprising at least one such wheel link device.

EP 2 709 860 B1 discloses a rotational damper for a motor vehicle, comprising at least one damper element, which is designed to damp a relative movement between a first mass mounted on the wheel suspension and a second mass mounted on the vehicle body. Furthermore, DE 10 2015 008 952 B3 discloses a vibration absorber for reducing vibrations on a chassis of a motor vehicle. DE 10 2020 107 781 A1 discloses a vibration absorbing device for a suspension of a motor vehicle wheel on a chassis of a motor vehicle. Moreover, DE 10 2016 212 662 A1 discloses a wheel suspension for a two-track vehicle.

An object of the present invention is to provide a wheel link device for a motor vehicle, in particular for a passenger car, and a motor vehicle comprising at least one such wheel link device, so that a particularly high level of driving comfort can be realized.

This object is achieved according to the invention by a wheel link device and by a motor vehicle equipped with such a wheel link device, in accordance with the features of the independent claim(s). The dependent claims relate to advantageous embodiments of the invention.

A first aspect of the invention relates to a wheel link device for a motor vehicle, in particular for a chassis of a motor vehicle. This means that the motor vehicle, which is preferably in the form of a passenger car and is also referred to as vehicle, in its finished state comprises the aforementioned chassis, which has the wheel link device. The motor vehicle has an interior space, which is also referred to as passenger compartment or passenger space and is formed or delimited by a structure of the motor vehicle, this structure preferably being in the form of a self-supporting body. The chassis is formed separately from the structure and connected to the structure, with the result that the structure and the motor vehicle overall can be or are supported downwardly, in the vertical direction of the motor vehicle, on the ground via the chassis. The chassis has for example at least or exactly two vehicle axles, which are arranged one behind the other and thus one following the other in the vehicle longitudinal direction and are also referred to simply as axles. The respective vehicle axle has at least or exactly two vehicle wheels, also referred to simply as wheels, the vehicle wheels of the respective vehicle axle being arranged on opposite sides of the motor vehicle in the transverse direction of the motor vehicle. The vehicle wheels are ground contact elements, via which the chassis and thus the structure and the motor vehicle overall can be or are supported downwardly, in the vehicle vertical direction, on the ground. If the motor vehicle is driven along the ground while the chassis and thus the structure and the motor vehicle are supported downwardly, in the vertical direction of the motor vehicle, on the ground via the ground contact elements, the ground contact elements (vehicle wheels) roll directly on the ground.

The wheel link device has a wheel link for guiding at least or exactly one of the wheels of the motor vehicle. The wheel link is also referred to as wheel guide link, spring link or link and may be in the form for example of a transverse link. The wheel link is also referred to as a first component. In other words, the wheel link is a first component of the wheel link device. When the following text refers to a vehicle wheel, it is to be understood, unless stated otherwise, to mean the vehicle wheel that is to be or is guided by means of the link. The feature that the vehicle wheel is to be, or is, guided by means of the wheel link is to be understood to mean that, first relative movements between the vehicle wheel and the structure along at least one first direction of movement are prevented or at least delimited by means of the wheel link. For example, the wheel link permits second relative movements between the vehicle wheel and the structure, in particular along at least one second direction of movement running for example obliquely or perpendicularly to the first direction of movement, selectively in particular in such a way that the wheel link permits inward and outward deflection movements of the vehicle wheel that take place in the vertical direction of the motor vehicle relative to the structure. Therefore, for example, the vehicle wheel can be or is attached to the structure in an articulated fashion by way of the wheel link as an intermediary element. For this, for example the wheel link is at least indirectly or directly coupled to the structure in an articulated fashion. The wheel link may be attached, for example by way of an axle carrier as an intermediary element that is formed separately from the structure, to the structure, in particular in an articulated fashion, in particular in such a way that the wheel link is attached to the axle carrier in an articulated fashion. The axle carrier is for example, in particular elastically, mounted on the structure and formed separately from the structure. In particular, the wheel link is at least indirectly attached to the structure in the articulated fashion in such a way that the wheel link is pivotable about an axis of rotation of the wheel link relative to the structure.

The wheel link device has a vibration absorber, which can be used to damp vibrations of the wheel link that occur in particular about the axis of rotation of the wheel link and/or relative to the structure. The vibration absorber, which is also referred to simply as an absorber, is in the form of a rotational absorber.

For example, the wheel link and, via the wheel link, the vehicle wheel are supported on the structure resiliently and with damping action via a spring and damper device, with the result that the spring and damper device is used to damp the inward and outward deflection movements of the vehicle wheel. In other words, the wheel link and thus the vehicle wheel are supported on the structure resiliently and with damping action by means of the spring and damper device with respect to the aforementioned inward and outward deflection movements of the vehicle wheel that take place relative to the structure in particular in the vehicle vertical direction. The vibration absorber, which is in the form of a rotational absorber, is provided in addition to the spring and damper device and in particular is arranged externally to the spring and damper device, and very particularly the spring and damper device is arranged externally to the rotational absorber.

In order now to be able to realize a particularly high level of driving comfort, in particular for individuals sitting in the interior space of the motor vehicle, such as for the driver of the motor vehicle, the vibration absorber has an absorber mass which is a second component of the wheel link device. In other words, the absorber mass is also referred to as second component. The absorber mass is pivotable about a pivot axis relative to the wheel link. It is conceivable for the pivot axis to coincide with the axis of rotation of the wheel link. It is also conceivable for the pivot axis to run obliquely or perpendicularly or askew to the axis of rotation of the wheel link.

The vibration absorber moreover has a coupling element, via which for example the absorber mass is pivotably coupled to the wheel link about the pivot axis relative to the wheel link. To damp the vibrations of the wheel link, the coupling element is elastically deformable in the event of a relative rotation between the components about the pivot axis. For example, the coupling element is coupled both to the absorber mass and to the wheel link in each case at least indirectly, in particular directly, in such a way that relative rotations between the components about the pivot axis lead to elastic deformation of the coupling element. Therefore, for example the coupling element is coupled both to the absorber mass and to the wheel link in each case at least indirectly, in particular directly, so as to transmit torques that occur about the pivot axis. Expressed differently again, the components are pivoted relative to one another about the pivot axis, in particular in that the wheel link is pivoted about the axis of rotation of the wheel link relative to the structure, in particular owing to an outward deflection movement or an inward deflection movement of the vehicle wheel, and this results in a pivoting movement of the absorber mass about the pivot axis and relative to the wheel link, thus causing the coupling element to elastically deform, as a result of which vibrations of the wheel link are damped. The fact that the components are pivoted or pivotable about the pivot axis relative to one another is to be understood for example to mean that the absorber mass is pivoted or pivotable about the pivot axis and relative to the wheel link, in particular with respect to an imaginary, three-dimensional Cartesian coordinate system which is established on the wheel link and through the origin of which the pivot axis runs. The fact that the components are pivoted or pivotable about the pivot axis relative to one another can also be understood to mean that the wheel link is pivoted or pivotable about the pivot axis and relative to the absorber mass, in particular with respect to an imaginary, three-dimensional Cartesian coordinate system which is established on the absorber mass and through the origin of which the pivot axis runs. Therefore, the components are pivotable about the pivot axis relative to one another by the inward and outward deflection movements of the vehicle wheel, as a result of which the coupling element can be elastically deformed, such that the coupling element is elastically deformable owing to the inward and outward deflection movements of the vehicle wheel. In particular, the coupling element is made of an elastically deformable material, in particular of an elastomer and/or rubber. For example, the coupling element extends in a circumferential direction, about the pivot axis, of the coupling element at least partially around, in particular at least predominantly around and thus at least around more than half of or else completely around, the pivot axis.

The wheel link device has, according to the invention, an elastically deformable first buffer, which is provided in addition to the coupling element and is also referred to as stop buffer. In an inactive position of the wheel link device, the first buffer is spaced apart, in particular completely, from at least or exactly one of the components. The wheel link device assumes its inactive position when the wheel link device is in its fitted position and is inactive, which is to say stationary. The wheel link device assumes its fitted position in the finished state of the motor vehicle equipped with the wheel link device. In particular, the wheel link device assumes its inactive position or the wheel link device is in its inactive position when the motor vehicle comprising the wheel link device is at a standstill on a horizontal plane and the wheel link device and in particular also the vehicle wheel do not perform any movements. It is also conceivable for the wheel link device to assume its inactive position when the motor vehicle travels along a plane which can run horizontally or run obliquely to the horizontal, while the vehicle wheel does not perform any inward or outward deflection movements relative to the structure. In particular, in the inactive position of the wheel link device, the coupling element is slightly elastically deformed, which is to say biased, owing to the mass or the weight of the absorber mass at least with respect to the pivot axis, which is to say at least when considered about the pivot axis. If the wheel performs an inward or outward deflection movement relative to the structure for example from the inactive position, for example the coupling element is elastically deformed to a greater extent than in the inactive position in particular owing to the inertia of the absorber mass with respect to the pivot axis, which is to say when considered about the pivot axis, this elastic deformation causing vibrations of the wheel link to be damped.

It is contemplated for the first buffer, in the inactive position, to be spaced apart from the two components, in particular completely, or in the inactive position the first buffer to be spaced apart from one of the components and supported, in particular directly, on the other component, in particular in such a way that the first buffer in the inactive position rests at least indirectly, in particular directly, on the other component. The first buffer thus makes it possible to prevent the wheel link from directly striking the absorber mass. This means that in the inactive position the first buffer is spaced apart from the at least or exactly one component by a first spacing and thus is at the first spacing from the at least or exactly one component. It is also conceivable for the first buffer, in the inactive position, to be spaced apart from the other component by a second spacing and thus to be at the second spacing from the other component. If, for example, the components are pivoted relative to one another about the pivot axis, for example by the vehicle wheel being deflected inward or outward and thus the wheel link being pivoted about the axis of rotation of the wheel link relative to the structure, as a result of which the wheel link device is moved out of its inactive position and has the effect of making the absorber mass pivot about the pivot axis relative to the wheel link, then for example the respective component, after the respective spacing has been overcome or traversed, comes into at least indirect, in particular direct, supporting contact with the first buffer. In other words, if the components are pivoted, for example owing to an inward deflection movement or outward deflection movement of the vehicle wheel, relative to one another about the pivot axis in such a way that the components, in particular respective partial regions of the components, are pivoted toward one another about the pivot axis, then, after the respective spacing has been overcome or traversed, the respective component initially comes into at least indirect, in particular into direct, supporting contact with the first buffer. If the components, or the partial regions of the components, continue to be pivoted toward one another about the pivot axis, the first buffer, in particular between the partial regions of the components, is elastically deformed, in particular elastically compressed, which is to say made to buckle, with the first buffer damping the relative movement between the components and preventing the components from directly striking one another. Consequently, undesired noise that can result from the components directly striking one another can be avoided. This is advantageous in particular whenever the components are each made of a metal material. The first buffer can therefore prevent the metal materials from directly striking one another. In particular, in the inactive position the absorber mass is in a starting position, in particular when considered relative to the wheel link, with the absorber mass for example assuming the starting position relative to the wheel link in particular with respect to the coordinate system established on the wheel link, in particular and very particularly only whenever the wheel link device is inactive, which is to say is in its inactive position, in which in particular relative movements between the wheel link and the absorber mass, in particular the vibration absorber overall, are prevented.

The wheel link device has, according to the invention, a second buffer which is provided in addition to the coupling element and in addition to the first buffer and is elastically deformable. In the inactive position of the wheel link device, the second buffer is supported on both components, in particular in each case at least indirectly or directly, for example in such a way that in the inactive position the second buffer rests at least indirectly, in particular directly, against both components. Therefore, for example the other component is already in the inactive position and thus already rests against the first buffer and the second buffer when the at least or exactly one component is still spaced apart from the first buffer and rests against the second buffer. As a result, by means of the second buffer a tuning of the vibration absorber, also referred to as absorber tuning, can be or is realized, which is to say can be or is brought about, in particular to the effect that a natural frequency, also referred to as absorber frequency, of the vibration absorber is influenced or set by the second buffer. In the case of the invention, therefore, use of the buffer provides a functional separation. For the functional separation, the first buffer performs a stop function, which includes using the first buffer to prevent the components from directly striking one another. For the functional separation, the second buffer performs a tuning function, the scope of which includes influencing, which is to say setting and thus tuning, the absorber frequency by way of the second buffer. The stop function and the tuning function are also referred to in summary as functions. The functional separation makes it possible for the buffers to be selectively, in particular in design terms, tuned to or configured for the respective function they must perform such that both functions can be performed effectively and efficiently. Consequently, it is possible on the one hand to particularly effectively and efficiently avoid the components directly striking one another. On the other hand, it is possible to effectively and efficiently tune, set or configure the absorber frequency of the vibration absorber selectively, in such a way that in particular vibrations of the wheel link about the pivot axis can be selectively and advantageously damped by means of the vibration absorber. This makes it possible to realize a particularly high level of driving comfort. Expressed differently still, the first buffer can be selectively configured for the stop function and the second buffer can be selectively configured for the tuning function, it being possible to configure the first buffer for the stop function without adversely affecting the configuration of the second buffer for the tuning function, and it being possible to configure the second buffer for the tuning function without influencing the configuration of the first buffer for the stop function. This makes it possible to present a particularly high level of auditory and thus driving comfort.

Since in the inactive position the first buffer is spaced apart at least from the one component, the first buffer is in engagement or comes into engagement only in the event of large vibration travels, which is to say only whenever the components are pivoted relative to one another about the pivot axis far enough or to a great enough extent that the respective spacing is eliminated, so that the two components come into supporting contact with the first buffer. In the event of only small vibration travels, which is to say whenever the components are pivoted relative to one another about the pivot axis only to such a small or slight extent that the respective spacing is not eliminated, with the result that the second buffer is supported on both components whereas the first buffer is spaced apart from the at least or exactly one component or from both components, the first buffer does not come into engagement, which is to say the first buffer is not elastically deformed, and thus the damping of the vibrations of the wheel link that can be or is brought about by the second buffer is not adversely affected by the first buffer. In other words, the first buffer then contributes to damping vibrations of the wheel link. Since the first buffer comes into engagement only in the event of large vibrations, the first buffer can prevent the absorber mass from striking the wheel link, which is in the form of for example a transverse link, or vice versa, as a result of which it is possible to avoid a knocking noise resulting from such a striking action. The second buffer for the tuning function, also referred to as absorber function, is set up such that, in the inactive position, in particular at all times and thus preferably in any possible pivot position of the wheel link and of the absorber mass, it is in engagement and therefore supported at least indirectly, in particular directly, on both components. Therefore, the second buffer can have the effect of damping in particular vibrations of the wheel link already in the event of small excitations, and therefore already in the event of small deflections, in the event of which the first buffer is spaced apart from at least one of the components or from both components and the components are pivoted relative to one another.

The invention is based in particular on the finding that whenever both functions are integrated in the respective buffer, which is to say both in the first buffer and in the second buffer, it may not be possible to realize sufficient vibration absorption by means of the vibration absorber in all temperature and excitation ranges. Usually, the vibration absorber is then set up and optimized for exactly one temperature and exactly one excitation. This dependence on excitation and temperature can then be resolved or at least reduced by the described functional separation, with the result that particularly advantageous vibration absorption and thus a particularly high level of driving comfort can be realized. At the same time, it is possible to effectively and efficiently prevent the wheel link from directly striking the absorber mass, and vice versa.

In order to be able to particularly effectively and efficiently damp vibrations and thus realize a particularly high level of driving comfort, in one embodiment of the invention it is provided that the first buffer is made of an elastically deformable material, in particular of an elastomer and/or rubber. As an alternative or in addition, the second buffer is made of an elastically deformable material, in particular of an elastomer and/or rubber. It is conceivable for the first buffer and the second buffer to be made of the same elastically deformable material, or for the first buffer to be made of a first elastically deformable material and the second buffer to be made of a second, different elastically deformable material to the first elastically deformable material. This makes it possible to tune the buffers selectively and individually and in particular independently of one another to the respective function.

In order on the one hand to be able to effectively and efficiently damp vibrations in particular using the first buffer and on the other hand to effectively and efficiently prevent the wheel link from impacting against, and therefore striking the absorber mass, or vice versa, a further embodiment of the invention provides that the first buffer has a first damper characteristic curve and the second buffer has a second, different damper characteristic curve to the first damper characteristic curve.

It has been shown to be particularly advantageous in this respect if the respective damper characteristic curve describes a relationship between an external force acting on the respective buffer and a travel. The external force acting on the respective buffer is exerted for example by the wheel link, in particular on the one hand, and for example, in particular on the other hand, by the absorber mass on the respective buffer. The travel is for example a travel through which the respective buffer, as a result of the respective external force acting on the respective buffer, is elastically deformed and thus made to buckle, which is to say compressed and thus longitudinally shortened, in particular along a straight line of action, along which the external force acts on the respective buffer. As an alternative, the travel may be a travel through which the absorber mass pivots out of the starting position relative to the wheel link about the pivot axis and as a result is moved toward the wheel link, in particular when the wheel link device is moved out of its inactive position, which is to say for example when the vehicle wheel performs an inward or outward deflection movement relative to the structure. The fact that the components are pivotable or pivoted relative to one another in such a way that the components can be or are pivoted toward one another is to be understood to mean that at least respective partial regions of the components are pivoted toward one another by the components being pivoted relative to one another.

In order to particularly advantageously realize the functional separation and thus be able to both effectively and efficiently prevent mutual striking and effectively and efficiently damp vibrations of the wheel link, a further embodiment of the invention provides that the buffers have different external shapes and/or different external dimensions. A further embodiment is distinguished in that the two buffers are held, in particular directly, on the at least or exactly one component, as a result of which the buffers can be conjointly pivoted with the at least one component. In addition, as a result in the inactive position the first buffer is supported at least indirectly, in particular directly, on the at least or exactly one component and spaced apart from the other component, in particular completely, such that in the inactive position the first buffer is not supported on the other component. In addition, as a result in the inactive position the second buffer is at least indirectly, in particular directly, supported on both components, in particular in such a way that in the inactive position the second buffer rests at least indirectly, in particular directly, on both components. As a result, already in the event of small deflections or travels through which the wheel link is pivoted and thus deflected relative to the absorber mass about the pivot axis, it is possible to advantageously damp vibrations, specifically by means of the coupling element, by means of the absorber mass and by means of the second buffer and in particular without the other component coming into supporting contact with the first buffer. In the event of very large travels or deflections, also referred to as vibration travels, through which the components are pivoted in particular about the pivot axis relative to one another, the first buffer can reliably prevent the components from striking one another, with the result that a particularly advantageous noise level and thus a particularly high level of driving comfort can be presented.

It has been shown to be particularly advantageous in this respect if the at least or exactly one component is the absorber mass. This makes it possible to effectively and efficiently damp vibrations of the wheel link.

In order to be able to effectively and efficiently damp the vibrations of the wheel link by means of the second buffer, without this damping of the vibrations being undesirably adversely affected by the first buffer, a further embodiment of the invention provides that the first buffer in the inactive position is spaced apart from the at least or exactly one component by the aforementioned spacing, the spacing being at least one centimeter.

It has been shown to be particularly advantageous if the spacing is at least two centimeters, in particular at least three centimeters and very particularly more than three centimeters and preferably at most ten centimeters, in particular at most five centimeters, as a result of which on the one hand the vibrations of the wheel link can be advantageously damped. On the other hand, this makes it possible to reliably prevent the components from striking one another.

A second aspect of the invention relates to a motor vehicle which is preferably in the form of a passenger car and comprises at least one wheel link device according to the first aspect of the invention. Advantages and advantageous embodiments of the first aspect of the invention are to be regarded as advantages and advantageous embodiments of the second aspect of the invention, and vice versa.

Further details of the invention will emerge from the subsequent description of a preferred exemplary embodiment with the associated drawings.

### BRIEF DESCRIPTION OF THE DRAWINGS

FIG. 1 is a schematic perspective view of a detail of a wheel link device for a motor vehicle; and

FIG. 2 shows damper characteristic curves of buffers of the wheel link device.

In the figures, elements that are the same or have the same function are provided with the same reference signs.

### DETAILED DESCRIPTION OF THE DRAWINGS

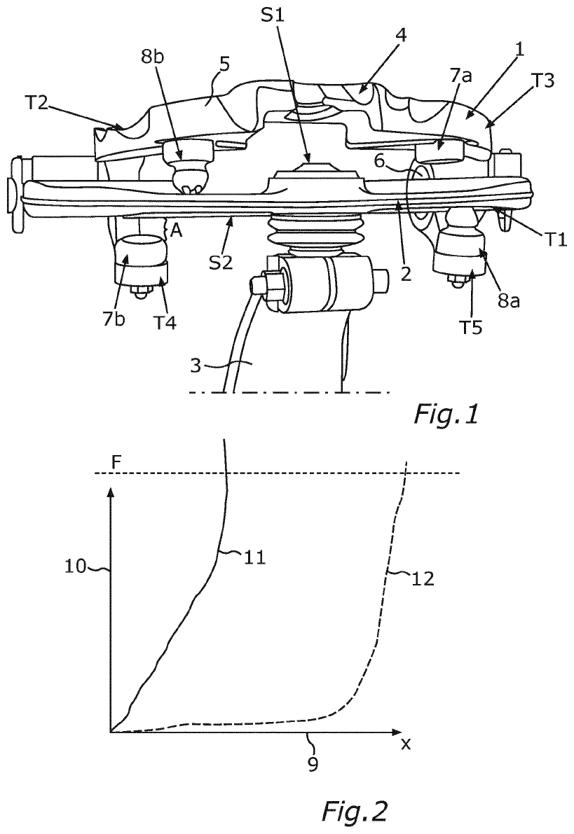

FIG. 1 shows a schematic perspective view of a detail of a wheel link device 1 for a motor vehicle, also referred to as vehicle. This means that the motor vehicle, which is preferably in the form of a passenger car, in its finished state comprises the wheel link device 1. In its finished state, the motor vehicle comprises for example at least or exactly two vehicle axles, which are arranged one behind the other in the longitudinal direction of the motor vehicle and can also be referred to simply as axles. The respective vehicle axle has at least or exactly two vehicle wheels, which are also simply referred to as wheels. The respective vehicle wheels of the respective vehicle axis are arranged on opposite sides of the motor vehicle in the transverse direction of the motor vehicle. The vehicle wheels are ground contact elements, via which the vehicle can be or is supported downwardly, in the vertical direction of the motor vehicle, on the ground. If the motor vehicle is driven along the ground while the motor vehicle is supported downwardly, in the vertical direction of the motor vehicle, on the ground via the ground contact elements, the ground contact elements roll, in particular directly, on the ground.

The motor vehicle also comprises a structure, which is in the form for example of a self-supporting body and which also forms or delimits an interior space, referred to as passenger compartment or passenger space, of the motor vehicle. While the motor vehicle is traveling, individuals, such as the driver of the motor vehicle, can be accommodated in the interior space. For example, the vehicle wheels of at least or exactly one of the vehicle axles may be attached in articulated fashion to the structure by means of a wheel link device, such as the wheel link device 1. It is also conceivable for the vehicle wheels of both axles to be attached in articulated fashion to the structure by means of a respective wheel link device, such as the wheel link device 1. This means that the wheel link device 1 is assigned in particular exactly one of the vehicle wheels, the vehicle wheel assigned to the wheel link device 1 being attached in articulated fashion to the structure by means of the wheel link device 1. When the following text refers to the vehicle wheel, this is understood, unless stated otherwise, to mean the vehicle wheel which is assigned to the wheel link device 1 and is attached in articulated fashion to the structure by means of the wheel link device 1.

The wheel link device 1 has a wheel link 2, by means of which the vehicle wheel is to be or is guided relative to the structure. This means that the wheel link 2 is used to prevent or at least delimit first relative movements between the vehicle wheel and the structure, the wheel link 2 selectively permitting second relative movements between the vehicle wheel and the structure. The second relative movements result for example from inward and outward deflection movements of the vehicle wheel that occur in particular in the vehicle vertical direction relative to the structure.

The wheel link device 1 is a constituent part of a chassis of the motor vehicle. The chassis also comprises a wheel carrier 3, which is assigned to the vehicle wheel and on which the vehicle wheel is rotatably mounted about an axis of rotation of the wheel relative to the wheel carrier 3. For this, the wheel carrier 3 is assigned a wheel hub, which is rotatably mounted on the wheel carrier 3 about the axis of rotation of the wheel relative to the wheel carrier 3 in particular via at least or exactly one rolling bearing. The vehicle wheel is connected, in particular nondestructively detachably, to the wheel hub for conjoint rotation, with the result that the vehicle wheel and the wheel hub can rotate together, which is to say at the same time, about the axis of rotation of the wheel relative to the wheel carrier 3, in particular whenever the vehicle is driven along the ground while the vehicle is supported downward, in the vehicle vertical direction, on the ground via the ground contact elements. For example, the vehicle wheel is a front wheel, and therefore the vehicle axle comprising the vehicle wheel is a front axle. For example, the wheel carrier 3 is pivotably coupled to the wheel link 2 about a steering axis relative to the wheel link 2, with the result that for example the vehicle wheel is a steerable vehicle wheel. The wheel carrier 3 and therewith the vehicle wheel can be pivoted about the steering axis relative to the wheel link 2 and relative to the structure, in order to thereby be able to bring about changes in driving direction, lane changes and cornering of the motor vehicle. For example, the steering axis runs obliquely or perpendicularly or askew to the axis of rotation of the wheel.

The wheel link 2 is assigned for example a spring and damper device, not illustrated in the figures, via which the wheel link 2 and thus the vehicle wheel are resiliently supported with damping action in particular in the vehicle vertical direction, in such a way that the vehicle wheel is resiliently supported with damping action on the structure via the spring and damper device in terms of the inward and outward deflection movement of the wheel relative to the structure. Therefore, the vehicle wheel is attached in articulated fashion to the structure via the wheel link 2 in such a way that the wheel link 2 permits the inward and outward deflection movements of the vehicle wheel relative to the structure. For this, for example the wheel link 2 is pivotably attached at least indirectly to the structure about an axis of rotation of the wheel link relative to the structure.

The wheel link device 1 furthermore comprises a vibration absorber 4 for damping vibrations of the wheel link 2, the vibration absorber 4 being in the form of a rotational absorber, and therefore a rotational damper. In the exemplary embodiment shown in the figures, the wheel link 2 is a transverse link.

In order to now be able to realize a particularly high level of driving comfort for individuals accommodated in the interior space of the motor vehicle, the vibration absorber 4 has an absorber mass 5, the mass of which is preferably greater than that of the wheel link 2. The wheel link 2 is also referred to as first component, and the absorber mass 5 is also referred to as second component. The absorber mass 5 is pivotable about a pivot axis relative to the wheel link 2. In particular, the absorber mass 5 is pivotably coupled to the wheel link 2 about the pivot axis relative to the wheel link 2. In particular, it is provided that the absorber mass 5 is pivotably held, in particular mounted, on the wheel link 2 about the pivot axis relative to the wheel link 2. It is contemplated for the aforementioned axis of rotation of the wheel link to coincide with the pivot axis. It is also contemplated for the pivot axis to run perpendicularly or parallel or askew to the axis of rotation of the wheel link. With preference, the absorber mass 5 is attached to the structure exclusively via the wheel link 2, and therefore the absorber mass 5 is attached to the structure preferably in no other way than via the wheel link 2, which is to say not circumventing the wheel link 2.

The vibration absorber 4 also has at least one coupling element 6, which is partially shown in FIG. 1. For example, the vibration absorber 4 has at least or exactly two coupling elements, it being possible to transfer the preceding and following statements relating to the coupling element 6 readily also to the at least or exactly two coupling elements, and vice versa. To damp the vibrations of the wheel link 2, the coupling element 6 is elastically deformable in the event of a respective relative rotation between the components about the pivot axis. The respective relative rotation between the components about the pivot axis can be or is brought about by the respective inward deflection movement and the respective outward deflection movement. The inward deflection movement and the outward deflection movement of the vehicle wheel are also referred to in summary as wheel movements. Therefore, in particular the following is provided: If the vehicle wheel performs its respective wheel movement, as a result the wheel link 2 is pivoted relative to the structure about the axis of rotation of the wheel link, which can bring about a pivoting movement of the absorber mass 5 about the pivot axis and relative to the wheel link 2, and therefore the absorber mass 5 can be pivoted about the pivot axis relative to the wheel link 2. Expressed differently still, a pivoting of the wheel link 2 about the axis of rotation of the wheel link and relative to the structure makes it possible to bring about a pivoting of the absorber mass 5 about the pivot axis and relative to the wheel link 2. Therefore, the respective wheel movement can cause a relative rotation between the components about the pivot axis. As a result of this relative rotation between the components about the pivot axis, the coupling element 6, which is preferably made of an elastically deformable material, in particular of an elastomer, is elastically deformed, and this causes vibrations of the wheel link 2 in particular about the pivot axis to be damped. For example, the coupling element 6 is coupled to the components, in particular for conjoint rotation, so as to transmit torque with respect to the pivot axis, which is to say torques that act about the pivot axis, with the result that, as it were, in the event of the respective relative rotation between the components about the pivot axis, the coupling element 6 is inherently twisted and thus elastically deformed, in particular about the pivot axis.

In FIG. 1, the absorber mass 5 assumes its starting position with respect to the wheel link. The absorber mass 5, in particular the vibration absorber 4 overall, assumes its starting position in particular whenever the wheel link device 1 assumes its inactive position, which is to say whenever the wheel link device 1 is inactive, this being the case in particular when the motor vehicle is at a standstill on a horizontal plane and there are no relative movements between the vehicle wheel and the structure, and therefore there are also no relative movements between components of the wheel link device 1. In the starting position, the coupling element 6 is slightly elastically deformed, and thus biased, for example at least with respect to the pivot axis, which is to say at least when considered about the pivot axis. If now, for example, the vehicle wheel performs its inward deflection movement, as a result the wheel link 2 pivots upward, in the vehicle vertical direction, relative to the structure about the axis of rotation of the wheel link, and the wheel link device 1 is moved out of its inactive position. In particular owing to the inertia of the absorber mass due to the elastic coupling of the components via the coupling element 6, the absorber mass 5 is moved, in particular initially, not to the same extent as the wheel link 2, such that the absorber mass 5 is moved out of its starting position relative to the wheel link 2, in particular in such a way that at least respective, first partial regions of the components are pivoted toward one another and respective, second partial regions of the components are pivoted away from one another. In other words, for example the inward deflection movement brings about a relative rotation between the components about the pivot axis, as a result of which the coupling element 6 is elastically deformed at least when considered about the pivot axis, which is to say at least with respect to the pivot axis, in particular in such a way that the coupling element 6 is elastically deformed to a greater extent than in the inactive position when considered about the pivot axis. The same applies for the respective outward deflection movement of the vehicle wheel. If, for example, the absorber mass 5 is initially in its starting position shown in FIG. 1 relative to the wheel link 2, and if the vehicle wheel performs for example its outward deflection movement, such that the wheel link 2 is pivoted downward relative to the structure about the axis of rotation of the wheel link, as a result for example a relative rotation between the components about the pivot axis is brought about in particular owing to the inertia of the absorber mass 5. In this case, for example the two partial regions of the components are pivoted toward one another, and the first partial regions of the components are pivoted away from one another. This causes the coupling element 6 to be elastically deformed at least when considered about the pivot axis, in particular in such a way that the coupling element 6 is elastically deformed to a greater extent than in the inactive position when considered about the pivot axis. As a result, the vibrations of the wheel link 2 are damped.

Furthermore, the wheel link device 1, in particular the vibration absorber 4, has two elastically deformable first buffers 7a and 7b. Furthermore, the wheel link device 1, in particular the vibration absorber 4, has two elastically deformable second buffers 8a and 8b. FIG. 1 shows that at least one partial region T1 of the wheel link 2 is arranged between partial regions T2, T3, T4 and T5 of the absorber mass 5 in the vehicle vertical direction, in such a way that the partial regions T2 and T3 are arranged above the partial region T1 in the vehicle vertical direction and that the partial regions T4 and T5 are arranged below the partial region T1 in the vehicle vertical direction. In particular, for example the partial region T1 is overlapped upwardly, in the vehicle vertical direction, at least partially by the partial regions T2 and T3. As an alternative or in addition, for example the partial region T1 is overlapped downwardly, in the vehicle vertical direction, at least partially by the partial regions T4 and T5. This is discussed in more detail below. For example, the partial regions T2 and T3 are the first partial regions of the absorber mass 5, which in the event of the inward deflection movement of the vehicle wheel are pivoted toward the first partial regions of the wheel link 2. For example, the partial regions T4 and T5 are the second partial regions of the absorber mass 5, which in the event of the outward deflection movement of the vehicle wheel are pivoted toward the second partial regions of the wheel link 2. The first partial regions of the wheel link 2 are formed for example by the partial region T1, in particular by a first side S1 of the partial region T1 facing the partial regions T2 and T3. The second partial regions of the wheel link 2 are formed for example by the partial region T1, in particular by a second side S2 of the partial region T1 facing the partial regions T4 and T5, the second side S2 of this partial region facing away from the side S1, in particular downward in the vehicle vertical direction.

The respective first buffer 7a, b is spaced apart, in particular completely, from the wheel link 2 in the inactive position shown in FIG. 1 and thus in the starting position shown in FIG. 1 of the absorber mass 5, with the result that the first buffers 7a and 7b can be used to prevent the wheel link 2 from directly striking the absorber mass 5, specifically both when the wheel link 2 pivots upward in the vehicle vertical direction about the pivot axis and when the wheel link 2 pivots downward in the vehicle vertical direction about the pivot axis, which is to say both in the event of the respective inward deflection movement and in the event of the respective outward deflection movement of the vehicle wheel. The respective second buffer 8a, b is supported on both components, which is to say both on the absorber mass 5 and on the wheel link 2, in the inactive position and thus in the starting position of the absorber mass 5, with the result that the elastically deformable second buffers 8a and 8b can be used to damp vibrations of the wheel link 2 already when, and also whenever, the absorber mass 5 is pivoted only so slightly relative to the wheel link 2 that although the partial region T1 is pivoted toward the partial regions T2 and T3 or toward the partial regions T4 and T5 and thus the buffer 8b or 8a, respectively, is elastically deformed, the buffers 7a and 7b are each still completely spaced apart from the wheel link 2 and thus do not adversely affect the damping of vibrations of the wheel link 2 brought about by the buffer 8b or 8a, respectively. The buffer 7a, b becomes active only whenever the absorber mass 5 is pivoted far enough or to a great enough extent toward the wheel link 2 that the partial region T1 is pivoted toward the partial regions T2 and T3 or toward the partial regions T4 and T5 that the partial region T1 and thus the wheel link 2 comes into supporting contact with the buffer 7a or 7b, respectively. Then, the buffer 7a or 7b, respectively, is (also) elastically deformed, the buffer 7a or 7b preventing the partial region T1 from directly striking the partial regions T2 and T3 or the partial regions T4 and T5, respectively.

With preference, the buffers 7a and 7b and 8a and 8b are made of an elastically deformable material, in particular of an elastomer. FIG. 1 shows that the buffers 8a and 8b have the same external shape and the same external dimensions. The buffers 7a and 7b have the same external shape and the same external dimensions. However, the respective buffer 7a, b and the respective buffer 8a, b have different shapes and different external dimensions.

FIG. 1 shows that the buffer 7a is held, in particular directly, on the partial region T3 and thus on the absorber mass 5, and the buffer 8b is held, in particular directly, on the partial region T2 and thus on the absorber mass 5. The buffer 8a is held, in particular directly, on the partial region T5 and thus on the absorber mass 5, and the buffer 7b is held, in particular directly, on the partial region T4 and thus on the absorber mass 5. Therefore, the buffer 8b can advantageously damp vibrations of the wheel link 2 whenever the wheel link 2 is pivoted upward about the pivot axis relative to the structure, and therefore whenever the vehicle wheel performs its respective inward deflection movement. Accordingly, the buffer 7a can prevent the wheel link 2 from directly striking the absorber mass 5 when the wheel link 2 is pivoted upward about the axis of rotation of the wheel link relative to the structure, and therefore the vehicle wheel performs its inward deflection movement. Accordingly, the buffer 8a can damp vibrations of the wheel link 2 when the wheel link 2 is pivoted downward about the axis of rotation of the wheel link relative to the structure, and therefore the vehicle wheel performs its outward deflection movement. Accordingly, the buffer 7b can prevent the wheel link 2 from directly striking the absorber mass 5 when the wheel link 2 is pivoted downward about the axis of rotation of the wheel link relative to the structure, and therefore the vehicle wheel performs its outward deflection movement. The partial region T1, in particular the side S1, is overlapped upward, in the vehicle vertical direction, partially by the partial region T3 and thus by the buffer 7a and partially by the partial region T2 and thus by the buffer 8b. The partial region T1, in particular the side S2, is overlapped downward, in the vehicle vertical direction, partially by the partial region T4 and thus by the buffer 7b, and the partial region T1 is overlapped downward, in the vehicle vertical direction, partially by the partial region T5 and thus by the buffer 8a. It is evident that the buffers 7a, 7b, 8a and 8b are held, in particular directly, on the absorber mass 5 and thereby can be conjointly pivoted with the absorber mass 5, in particular relative to the wheel link 2. Moreover, as a result, in the inactive position and thus in the starting position the buffers 7a and 7b are supported, in particular directly, on the absorber mass 5 and spaced apart, in particular completely, from the wheel link 2, and in the inactive position and thus in the starting position the second buffers 8a and 8b are supported, in particular directly, on the components, in particular in such a way that in the inactive position and thus in the starting position the second buffers 8a and 8b rest, in particular directly, on both components.

FIG. 1 particularly clearly shows that in the inactive position and thus in the starting position the respective first buffer 7a, b is spaced apart from the wheel link 2, which is to say from the side S1 or S2, respectively, by a respective spacing. The respective spacing is particularly clearly shown by means of the buffer 7b and is denoted by A. With preference, the respective spacing A is at least one centimeter. Very preferably, the respective spacing A is at least two centimeters, in particular at least three centimeters, it very preferably being provided that the spacing A is greater than three centimeters and preferably less than ten centimeters, in particular less than five centimeters. As a result, in the event of small vibration travels through which the absorber mass 5 is outwardly deflected relative to the wheel link 2 about the pivot axis, the wheel link 2 remains reliably spaced apart from the buffers 7a and 7b, whereas the buffers 8a and 8b are supported on both components and thus damp vibrations of the wheel link 2 already in the event of the small vibrations.

FIG. 2 shows a graph, on the abscissa axis 9 of which a travel, denoted by x, is plotted. On the ordinate axis 10 of the graph, a force denoted by F is plotted. In the graph shown in FIG. 2, a first damper characteristic curve 11 and a second damper characteristic curve 12 are plotted. The damper characteristic curve 11 is for example a damper characteristic curve of the respective second buffer 8a, b. The damper characteristic curve 12 is for example a respective damper characteristic curve of the respective first buffer 7a, b. The force F is for example an external force acting on the respective buffer 7a, b and 8a, b, respectively, in particular along a straight line of action. The travel x is for example a travel which runs in particular along the line of action and through which the respective buffer 7a, b or 8a, b is elastically deformed and thereby made to buckle, which is to say compressed and thus longitudinally shortened, by the external force acting on the respective buffer 7a, b or 8a, 8b, in particular along the line of action. As an alternative, for example the travel x is a travel or a pivot angle through which the absorber mass 5 is pivoted about the pivot axis relative to the wheel link 2 or the wheel link 2 is pivoted about the axis of rotation of the wheel link relative to the structure.

The damper characteristic curves 11 and 12 make it clear that the buffers 8a and 8b damp vibrations of the wheel link 2, in particular by the buffers 8a and 8b being elastically deformed, while the wheel link 2 is still spaced apart from the buffers 7a and 7b and thus a force does not yet act on the buffers 7a and 7b. This is realized in that the buffers 8a and 8b rest against both components already in the inactive position and thus in the starting position and in particular at all times, which is to say preferably in any situation or position in which the absorber mass 5 can be pivoted about the pivot axis relative to the wheel link 2. Only whenever the components are pivoted to a great enough extent relative to one another about the pivot axis that the respective spacing A is eliminated, and therefore the wheel link 2 comes into supporting contact with the buffer 7a, b, does a force act on the buffer 7a, b and is the buffer 7a, b elastically deformed, as a result of which the buffer 7a, b prevents the wheel link 2 from directly striking the absorber mass 5, or vice versa. This makes it possible to ensure a particularly high level of driving comfort.

### List of Reference Signs

1 Wheel link device
2 Wheel link
3 Wheel carrier
4 Vibration absorber
5 Absorber mass
6 Coupling element
7a, b First buffer
8a, b Second buffer
9 Abscissa axis
10 Ordinate axis
11 Damper characteristic curve
12 Damper characteristic curve
F Force
T1 Partial region
T2 Partial region
T3 Partial region
T4 Partial region
T5 Partial region
x Travel

1.-10. (canceled)

11. A wheel link device for a motor vehicle, comprising:
a wheel link as a first component for guiding a wheel of the motor vehicle;
a vibration absorber, which is in the form of a rotational absorber, to damp vibrations of the wheel link, wherein
the vibration absorber comprises an absorber mass as a second component that is pivotable about a pivot axis relative to the wheel link, and at least one coupling element, which, for purposes of damping the vibrations, is elastically deformable in an event of a respective relative rotation between the first or second components about the pivot axis;
at least one elastically deformable, first buffer, which in an inactive position of the wheel link device is spaced apart from at least one of the first or second components, whereby the first buffer is useable to prevent the wheel link from directly striking the absorber mass; and
at least one elastically deformable, second buffer, which in the inactive position is supported on both of the first and second components.

12. The wheel link device according to claim 11, wherein
the first buffer and/or the second buffer is made of an elastically deformable material.

13. The wheel link device according to claim 11,
the first buffer has a first damper characteristic curve, and
the second buffer has a second, different, damper characteristic curve to the first damper characteristic curve.

14. The wheel link device according to claim 13, wherein
each respective damper characteristic curve describes a relationship between an external force acting on the respective buffer and a travel, through which the external force acting on the respective buffer causes the respective buffer to elastically deform and thus buckle.

15. The wheel link device according to claim 11, wherein
the first and second buffers have different external shapes and/or different external dimensions, and/or
the first and second buffers are arranged on a same side of the second component.

16. The wheel link device according to claim 11, wherein
the first and second buffers are held on at least one component, as a result of which:
the buffers are conjointly pivotable with the at least one component;
in the inactive position, the first buffer is supported on the at least one component and spaced apart from the other component; and
in the inactive position, the second buffer is supported on both components.

17. The wheel link device according to claim 16, wherein
the at least one component is the absorber mass.

18. The wheel link device accordingly to claim 11, wherein
the first buffer in the inactive position is spaced apart from the first component by a spacing, the spacing being at least one centimeter.

19. The wheel link device according to claim 18, wherein
the spacing is at least two centimeters.

20. The wheel link device according to claim 19 wherein
the spacing is at least three centimeters.

21. A motor vehicle comprising at least one wheel link device according to claim 11.
